(19) United States
(12) Patent Application Publication
(10) Pub. No.: US 2016/0018241 A1
(43) Pub. Date: Jan. 21, 2016

(54) APPARATUS AND METHOD FOR CREATING LOCATION BASED MULTIMEDIA CONTENTS

(71) Applicant: MtoV Inc., Daejeon (KR)

(72) Inventors: Sangsu JUNG, Seongnam-si (KR); Youngsam KIM, Daejeon (KR)

(21) Appl. No.: 14/528,806

(22) Filed: Oct. 30, 2014

(30) Foreign Application Priority Data
Jul. 16, 2014 (KR) 10-2014-0089681

(51) Int. Cl. G01C 21/36; G01C 21/34; G01S 19/42; G01C 21/00

(52) U.S. Cl. CPC G01C 21/3679; G01C 21/005; G01C 21/3446; G01C 21/3697; G01S 19/42

(57) ABSTRACT

Provided are an apparatus and a method for creating location based multimedia contents, which includes transmitting location based multimedia information including location information and time information collected, multimedia information corresponding to an image and sound provided from a camera, and additional information, storing the location information, the time information, the additional information, and the multimedia information in match with each other, extracting a route corresponding to an input search position, providing a search result for contents based on a partial section of the extracted route after searching for the contents, and selecting the contents based on a merge criterion when a plurality of location based multimedia contents related to the partial section are searched, and extracting only location based multimedia contents corresponding to each section from the search result for the contents and merging the extracted contents with each other to create new location based multimedia contents.

### BACKGROUND OF THE INVENTION

1. Field of the Invention

The present invention relates to an apparatus and a method for creating location based multimedia contents, capable of creating new location based multimedia contents according to partial sections using location based multimedia information.

2. Description of the Related Art

As generally known in the art, navigation markets are rapidly developed through the development and the propagation to the public of location based information systems, such as a global positioning system (GPS) or a Galileo project, so that a way finding service to find a destination based on present location information of a user is provided, 2-D map information is replaced with 3-D map information, and real-time traffic information is provided based on satellite information or terrestrial information.

Recently, map information, which was individually corrected and updated by a user, can be updated without an additional effort by the user through a wireless communication network, and the updating of the map information through the wireless communication network faces commercialization.

Meanwhile, a service (for example, a route search service and a road-view service) to guide a route by creating and utilizing various forms of location based multimedia is provided. However, since guidance information provided in the conventional service to guide the route provides a simple image to a user, the guidance information does not satisfy the demand of users who have usually experienced various media-related technologies and moving-picture-related technologies.

In addition, since the guidance information provided in the conventional service to guide the route is updated at a longer period (for example, six months or one year) based on collection periods and collection schemes preset by a service provider, the guidance information may not be latest information actually.

Further, since the guidance information, which is provided in the conventional route guide service, is individually provided without the multimedia interworking, only information corresponding to a relevant route may be guided, which makes it difficult for users to receive various services.

As a prior art, there is Korean Unexamined Patent Publication No. 10-2005-0103070 (published on Oct. 27, 2005) titled “Navigation Network System Using Cellular Phone, Navigation Apparatus, And Method For Providing Geographic Information Using The Same.”

### SUMMARY OF THE INVENTION

The present invention provides an apparatus and a method for creating location based multimedia contents, capable of creating new location based multimedia contents by independently separating a plurality of location based multimedia contents from each other or merging the location based multimedia contents with each other according to partial sections by using location information, time information, and multimedia information, thereby providing route guidance information appropriate to a user.

The present invention provides an apparatus and a method for creating location based multimedia contents, capable of creating new location based multimedia contents from partial location based multimedia contents, which are separated from each other in the unit of a partial section divided based on an intersection or a predetermined distance, using a merge criterion of a user, such as the first selection of the latest contents, the first selection of the same time contents, or the first selection of contents having many votes, thereby satisfying various demands of a user.

The present invention provides an apparatus and a method for creating location based multimedia contents, capable of creating new location based multimedia contents using location based multimedia information registered by a user and providing the new location based multimedia contents, thereby instantly providing route guidance information satisfying the demand of the user.

An objective of an embodiment of the present invention is not limited to the objectives described above, and it will be fully understood by those skilled in the art about other objectives not described from the following disclosure.

According to one aspect of the present invention, there is provided an apparatus for creating location based multimedia contents. The apparatus includes an information input unit including a GPS receiver and a camera and transmitting location based multimedia information including location information and time information collected by the GPS receiver, multimedia information corresponding to an image and sound provided from the camera, and additional information which is selectively added, an information storing unit storing the location information, the time information, the additional information, and the multimedia information included in the transmitted location based multimedia information in match with each other, a route extracting unit extracting a route corresponding to a search position to be searched if the search position is input, an information searching unit providing a search result for contents based on a partial section of the extracted route after searching for the contents based on the partial section of the extracted route, and selecting the contents based on a merge criterion when a plurality of location based multimedia contents related to the partial section are searched, and an information creating unit extracting only contents corresponding to each section among location based multimedia contents according to sections from the search result for the contents and merging the extracted contents with each other to create new location based multimedia contents.

According to another embodiment of the present invention, there is provided a method for creating location based multimedia contents. The method includes transmitting location based multimedia information including location information and time information collected through a GPS receiver, multimedia information corresponding to an image and sound provided from a camera, and additional information which is selectively added in an information input unit, storing the location information, the time information, the additional information, and the multimedia information included in match with each other in an information storing unit, extracting a route corresponding to a search position to be searched if the search position is input in a route extracting unit, providing a search result for contents based on a partial section of the extracted route after searching for the contents based on the partial section of the extracted route, and selecting the contents based on a merge criterion when a plurality of location based multimedia contents related to the partial section are searched in an information searching unit, and extracting only contents corresponding to each section among location based multimedia contents according to sections from the search result for the contents and merging the extracted contents with each other to create new location based multimedia contents in an information creating unit.

As described above, the present invention can create new location based multimedia contents by independently separating a plurality of location based multimedia contents from each other or merging the location based multimedia contents with each other according to partial sections by using location information, time information, and multimedia information, thereby providing route guidance information appropriate to a user.

The present invention can create new location based multimedia contents from partial location based multimedia contents, which are separated from each other in the unit of a partial section divided based on an intersection or a predetermined distance, using a merge criterion of a user, such as the first selection of the latest contents, the first selection of the same time contents, or the first selection of contents having many votes, thereby satisfying various demands of a user.

The present invention can create new location based multimedia contents using location based multimedia information registered by a user and providing the new location based multimedia contents, thereby instantly providing route guidance information satisfying the demand of the user.

### BRIEF DESCRIPTION OF THE DRAWINGS

FIG. 1 is a block diagram showing an apparatus for creating location based multimedia contents according to one embodiment of the present invention

FIG. 2 is a flowchart showing a procedure of creating location based multimedia contents according to another embodiment of the present invention.

FIGS. 3A to 3F are views to explain creating of new location based multimedia contents according to the embodiment of the present invention.

### DETAILED DESCRIPTION OF THE INVENTION

Advantages and features of embodiments of the present invention, and schemes of achieving the advantages and features will be apparently comprehended by those skilled in the art based on the embodiments, which are described later in detail, together with accompanying drawings. The present invention is not limited to the following embodiments but includes various applications and modifications. The present embodiments will make the disclosure of the present invention complete, and allow those skilled in the art to completely comprehend the scope of the present invention. The present invention is only defined within the scope of accompanying claims. The same reference numerals will be assigned the same elements throughout the specification.

In the following description of embodiments of the present invention, if the detailed description of generally-known functions or configurations may make the subject matter of the present invention unclear, the detailed description of the generally-known functions and configurations will be omitted. In addition, terminologies used in the following description are defined based on functions of the present invention, and may be varied depending on the intents of a user or an operator, or a custom. Accordingly, the terminologies should be defined based on the overall contents of the specification.

Hereinafter, an embodiment of the present invention will be described in detail with reference to accompanying drawings.

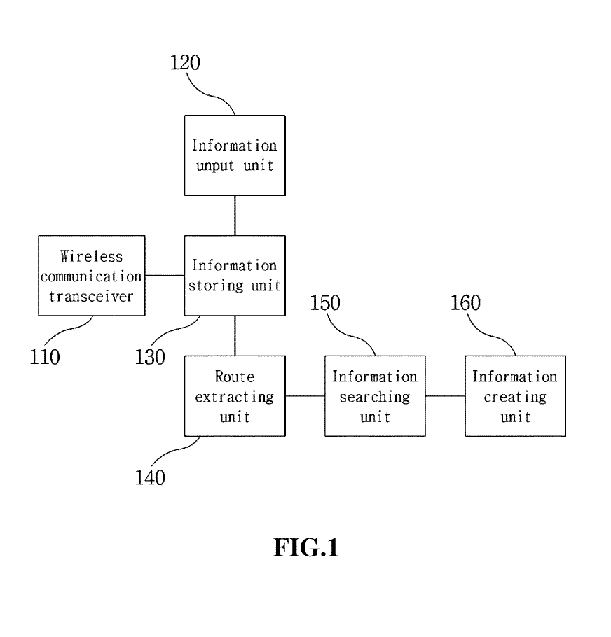

FIG. 1 is a block diagram showing an apparatus for creating location based multimedia contents according to one embodiment of the present invention.

Referring to FIG. 1, the apparatus for creating the location based multimedia contents according to one embodiment of the present invention may include a wireless communication transceiver 110, an information input unit 120, an information storing unit 130 a route extracting unit 140, an information searching unit 150, and an information creating unit 160.

The wireless communication transceiver 110 may include various wireless communication modules based on third and fourth generation communication schemes, such as a WiFi scheme, a CDMA scheme, and an LTE scheme, and communication schemes to be realized in the future to provide a wireless communication environment allowing the apparatus for creating the location based multimedia contents to transceive a wireless communication signal with a location based multimedia information providing server, which provides location based multimedia information, through a communication network realized based on a relevant communication scheme.

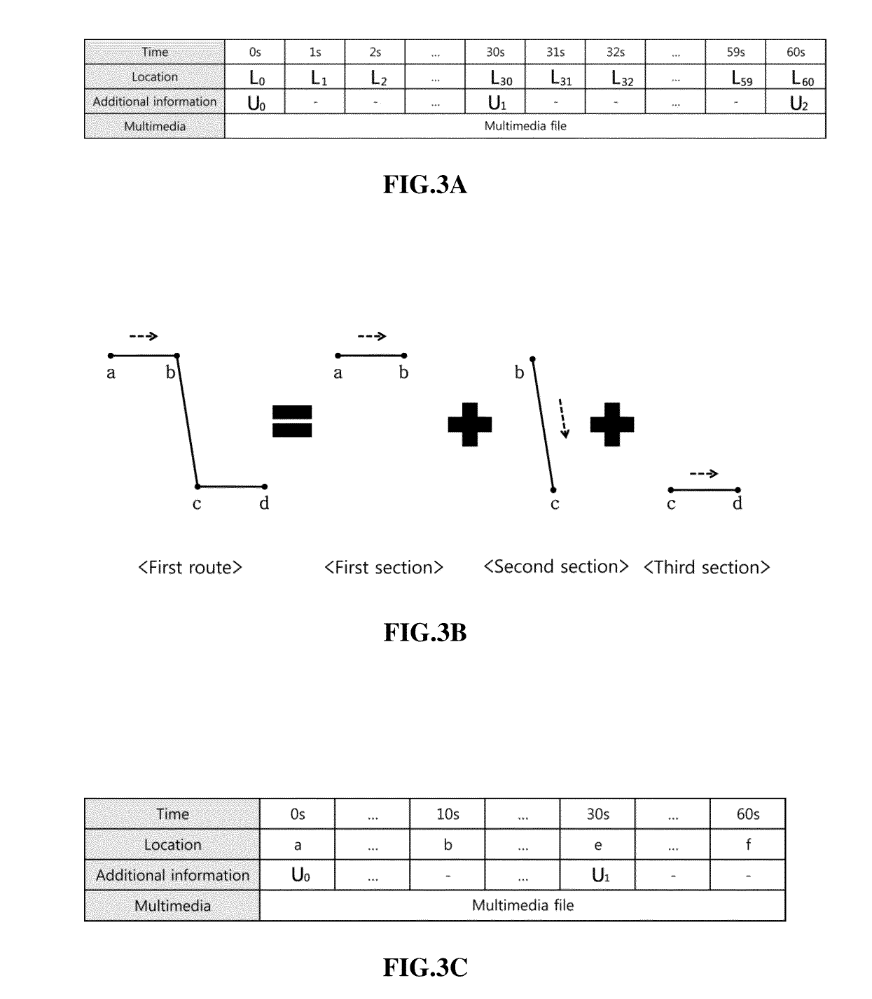

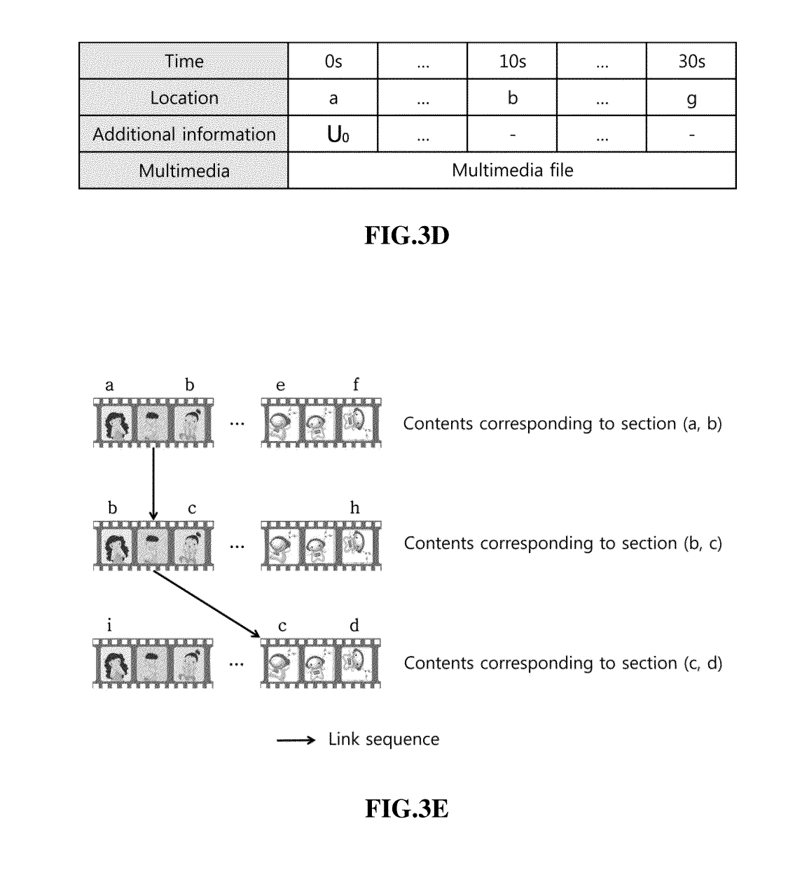

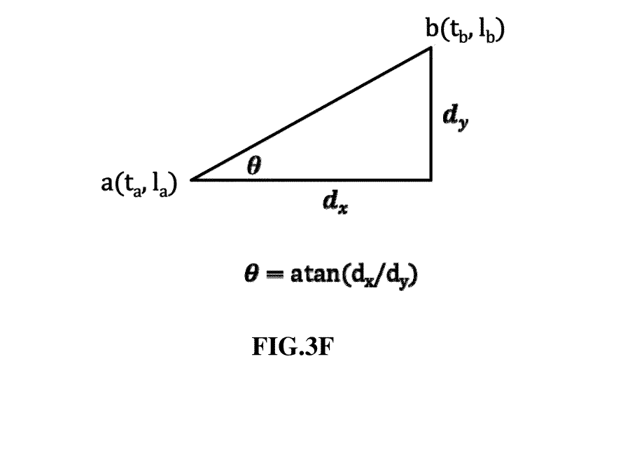

The information input unit 120 may include a GPS receiver, which receives location information from a GPS satellite, and a camera, which photographs an image, to store multimedia information, which is a set of location information and time information collected by the GPS receiver and a frame image corresponding to the image provided by the camera, in the information storing unit 130 as shown in FIG. 3A.

The information storing unit 130 may store additional information (for example, in the form of a text, an image, or audio), such as traffic information, route guidance information, or advertisement information, as occasion demands in match with the stored location based multimedia information stored in the information storing unit 130.

A play-back position of multimedia for the additional information, a position of the multimedia on a screen, and the type of the additional information may be set according to the selection of a user.

The information storing unit 130 matches location information, time information, and multimedia information with each other to be stored as the location based multimedia information. The location information, the time information, and the multimedia information may be extracted as occasion needs and provided to the location searching unit 150.

Further, the location based multimedia information stored in the information storing unit 130 may be extracted periodically or by user selection, and transmitted to the location based multimedia information providing server through the wireless communication transceiver 110.

If a user inputs positions (for example, a source or a destination) for search, the route extracting unit 140 may extract a route (for example, the shortest route) corresponding to the positions.

The information searching unit 150 may search for contents based on partial sections, such as sections obtained by dividing the route extracted from the route extracting unit 140 based on an intersection or a predetermined distance. When a plurality of location based multimedia contents related to the partial sections may be searched, and a plurality of search results are obtained, the optimal contents may be selected using a merge criterion (for example, the first selection of the latest contents, the same time contents, or contents having many votes).

For example, the route shown in FIG. 3B may be divided into partial sections (a, b), (b, c) and (c, d), and a plurality of location based multimedia contents related to an intersection corresponding to each section information may be searched with respect to the section information. FIGS. 3C and 3D show search results related to the section (a, b). Location based multimedia contents may be searched with respect to even each of sections (b, c) and (c, d). If several location based multimedia contents are searched with respect to each section, the optimal contents may be selected according to the merge criterion.

The information searching unit 150 may provide the search result for the contents to the information creating unit 160.

The information searching unit 150 calculates a moving direction using time information and location information of the search result for the contents, and separately searches only a case that the calculated moving direction belongs to the partial section and within an error range

For example, it can be recognized based on a source and a destination that a first section (a, b) shown in FIG. 3B has a moving direction from a to b. In FIG. 3C showing the search result related to the first section (a, b), it can be recognized based on time information that the moving direction is indicated from a to b.

In addition, angle calculation according to the moving direction may be performed based on an intersection between relevant sections. As shown in FIG. 3F, an angle θ between two points can be calculated from an x-axis distance dx and a y-axis distance dy which are calculated based on the location information between two points.

The information creating unit 160 may extract only contents corresponding to each section among location based multimedia contents according to sections from the search result for the contents provided by the information searching unit 150, and merge the extracted contents, thereby creating new location based multimedia contents.

For example, as shown in FIG. 3B, regarding location based multimedia contents finally selected according to partial sections, multimedia data may be separated from each other or linked with each other based on time information of multimedia information corresponding to each section for the play back of the multimedia data. As shown in FIG. 3E, the location based multimedia contents selected for each section may be partially merged or linked using time information and location information.

Although description has been made regarding that the apparatus for creating the location based multimedia contents includes the wireless communication transceiver 110, the apparatus for creating the location based multimedia contents may be provided without the wireless communication transceiver 110. In this case, the apparatus for creating the location based multimedia contents may search for and provide location based multimedia contents, which are self-created and stored therein, without wireless communication with the location based multimedia content providing server or downloading contents from the location based multimedia content providing server.

Therefore, according to the present invention, a plurality of location based multimedia contents are independently separated from each other or merged with each other according to partial sections using location information, time information and multimedia information, thereby creating new location based multimedia contents to provide route guidance information appropriate to the user.

In addition, the present invention can create new location based multimedia contents from partial location based multimedia contents, which are separated from each other in the unit of a partial section divided based on an intersection or a predetermined distance, using a merge criterion of a user, such as the first selection of the latest contents, the first selection of the same time contents, or the first selection of contents having many votes, thereby satisfying various demands of a user.

Further, the present invention can create new location based multimedia contents using location based multimedia information registered by a user and providing the new location based multimedia contents, thereby instantly providing route guidance information satisfying the demand of the user.

Hereinafter, description will be made regarding a procedure of creating new location based multimedia contents according to intersections, time information, and information of a moving direction based on primary and secondarily search results in the apparatus for creating the location based contents having the above structure.

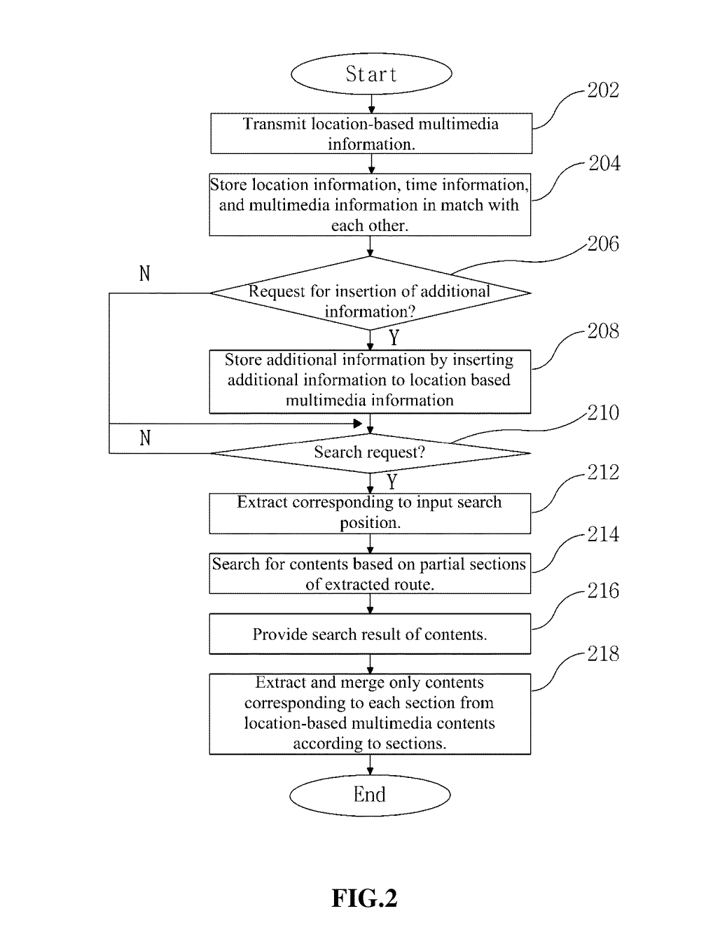

FIG. 2 is a flowchart showing a procedure of creating location based multimedia contents according to another embodiment of the present invention step by step.

Referring to FIG. 2, the information input unit 120 may transmit the location based multimedia information including location information and time information collected by the GPS receiver and multimedia information corresponding to an image and a sound provided from the camera to the information storing unit 130 (step 202).

In addition, the information storing unit 130 may store the location information, the time information, and the multimedia information in match with each other (step 204).

Meanwhile, the information storing unit 130 checks if a user inputs a request for the insertion of required additional information into the location based multimedia information (step 206).

If the request for the insertion of the addition information is input according to a check result in step 206, the information storing unit 130 may store the additional information required by the user together with the location based multimedia information if the additional information such as traffic information and guidance information stored in the form of a text, an image, or audio is selected (step 208). A play-back position of multimedia for the additional information, a position of the multimedia on a screen, and the type of information may be set according to the selection of the user.

Meanwhile, if the request for the insertion of the additional information is not input according to the check result in step 206, the route extracting unit 140 checks if the user inputs a position that the user wants to search for and requests the search for the position (step 210).

If there is no search request for the position according to the check result in step 210, the apparatus waits for the search request. If the search for the position is requested, the route extracting unit 140 may extract a route corresponding to the position (step 212). For example, the route may refer to the shortest route.

Meanwhile, the information searching unit 150 may search for contents based on partial sections, such as sections obtained by dividing the route extracted from the route extracting unit 140 based on an intersection or a predetermined distance (step 214). The search for contents may be performed by selecting the optimal contents according to a merge criterion (for example, the first selection of the latest contents, the same time contents, or contents having many votes) when a plurality of location based multimedia contents related to partial sections are searched and when a plurality of results are searched. The merge criterion may be set by including at least one of the first selection of the latest contents, the first selection of the same time contents, and the first selection of contents having many votes.

For example, the route shown in FIG. 3B may be divided into partial sections (a, b), (b, c) and (c, d), and a plurality of location based multimedia contents related to an intersection corresponding to each section information may be searched with respect to the section information. FIGS. 3C and 3D show search results related to the section (a, b). Location based multimedia contents may be searched with respect to each of even sections (b, c) and (c, d). If several location based multimedia contents are searched with respect to each section, the optimal contents may be selected according to the merge criterion.

The information searching unit 150 may provide the search result for the contents to the information creating unit 160 (step 216). The information searching unit 150 calculates a moving direction using time information and location information of the search result for the contents, and separately searches only a case that the calculated moving direction belongs to the partial section and within an error range.

For example, it can be recognized based on a source and a destination that a first section (a, b) shown in FIG. 3B has a moving direction from a to b. In FIG. 3C showing the search result related to the first section (a, b), it can be recognized based on time information that the moving direction is indicated from a to b.

In addition, angle calculation according to the moving direction may be performed based on an intersection between relevant sections. As shown in FIG. 3F, an angle θ between two points can be calculated from an x-axis distance dx and a y-axis distance dy which are calculated based on the location information between two points.

In addition, the information creating unit 160 may extract only contents corresponding to each section among location based multimedia contents according to sections from the search result for the contents provided by the information searching unit 150, and merge the extracted contents, thereby creating new location based multimedia contents (step 218).

For example, as shown in FIG. 3B, regarding location based multimedia contents finally selected according to partial sections, multimedia data may be separated from each other or linked with each other based on time information of multimedia information corresponding to each section for the play back of the multimedia data. As shown in FIG. 3E, the location based multimedia contents selected for each section may be partially merged or linked using time information and location information.

The present invention can create new location based multimedia contents by independently separating a plurality of location based multimedia contents from each other or merging the location based multimedia contents with each other according to partial sections by using location information, time information, and multimedia information, thereby providing route guidance information appropriate to a user.

The present invention can create new location based multimedia contents from partial location based multimedia contents, which are separated from each other in the unit of a partial section divided based on an intersection or a predetermined distance, using a merge criterion of a user, such as the first selection of the latest contents, the first selection of the same time contents, or the first selection of contents having many votes, thereby satisfying various demands of a user.

The present invention can create new location based multimedia contents using location based multimedia information registered by a user and providing the new location based multimedia contents, thereby instantly providing route guidance information satisfying the demand of the user.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An apparatus for creating location based multimedia contents, the apparatus comprising:
an information input unit including a GPS receiver and a camera and transmitting location based multimedia information including location information and time information collected by the GPS receiver, multimedia information corresponding to an image and sound provided from the camera, and additional information which is selectively added;
an information storing unit storing the location information, the time information, the additional information, and the multimedia information included in the transmitted location based multimedia information in match with each other;
a route extracting unit extracting a route corresponding to a search position to be searched if the search position is input;
an information searching unit providing a search result for contents based on a partial section of the extracted route after searching for the contents based on the partial section of the extracted route, and selecting the contents based on a merge criterion when a plurality of location based multimedia contents related to the partial section are searched; and
an information creating unit extracting only contents corresponding to each section among location based multimedia contents according to sections from the search result for the contents and merging the extracted contents with each other to create new location based multimedia contents,
wherein the information searching unit calculates a moving direction using time information and location information of the search result for the contents, and separately searches only a case that the calculated moving direction belongs to the partial section of the route and within an error range.

2. The apparatus of claim 1, further comprising a wireless communication transceiver to provide a wireless communication environment by transceiving a wireless communication signal,
wherein the information searching unit searches for and downloads location based multimedia information having the search position set as a destination in a location based multimedia information providing server.

3. The apparatus of claim 1, wherein the merge criterion is set by including at least one of first selection of latest contents, first selection of same time contents, and first selection of contents having many votes.

4. The apparatus of claim 2, wherein the merge criterion is set by including at least one of first selection of latest contents, first selection of same time contents, and first selection of contents having many votes.

5. A method for creating location based multimedia contents, the method comprising:
transmitting location based multimedia information including location information and time information collected through a GPS receiver, multimedia information corresponding to an image and sound provided from a camera, and additional information which is selectively added in an information input unit;
storing the location information, the time information, the additional information, and the multimedia information included in match with each other in an information storing unit;
extracting a route corresponding to a search position to be searched if the search position is input in a route extracting unit;
providing a search result for contents based on a partial section of the extracted route after searching for the contents based on the partial section of the extracted route, and selecting the contents based on a merge criterion when a plurality of location based multimedia contents related to the partial section are searched in an information searching unit; and
extracting only contents corresponding to each section among location based multimedia contents according to sections from the search result for the contents and merging the extracted contents with each other to create new location based multimedia contents in an information creating unit,
wherein the providing of the search result for the contents comprising calculating a moving direction using time information and location information of the search result for the contents, and separately search only a case that the calculated moving direction belongs to the partial section of the route and within an error range.

6. The method of claim 4, wherein the extracting of the route comprises searching for and downloading location based multimedia information having the search position as a destination from a location based multimedia information providing server with respect to the input search position.

7. The method of claim 5, wherein the merge criterion is set by including at least one of first selection of latest contents, first selection of same time contents, and first selection of contents having many votes.

8. The method of claim 6, wherein the merge criterion is set by including at least one of first selection of latest contents, first selection of same time contents, and first selection of contents having many votes.
